(19) United States
(12) Patent Application Publication
(10) Pub. No.: US 2026/0336383 A1
(43) Pub. Date: Oct. 29, 2026

(54) ELECTRIC WHEEL HUB DRIVE FOR A MOTOR VEHICLE

(71) Applicant: MERCEDES-BENZ GROUP AG, Stuttgart (DE)

(72) Inventors: Fabian SCHWED, Esslingen am Neckar (DE); Michael SCHMIDT, Wernau (DE); Arthur ADAM, Sindelfingen (DE); Johannes DEHN, Hochdorf (DE); Jessica ROOSZ, Esslingen (DE)

(21) Appl. No.: 19/136,593

(22) PCT Filed: Nov. 15, 2023
(86) PCT No.: PCT/EP2023/081955

§ 371 Date: Jun. 6, 2025

(30) Foreign Application Priority Data
Dec. 7, 2022 (DE) 10 2022 004 586.9

(51) Int. Cl. B60K 7/00; H02K 5/20; H02K 7/00

(52) U.S. Cl. CPC B60K 7/0007; H02K 5/20; H02K 7/003; H02K 7/006; B60K 2007/0038; B60K 2007/0092

(57) ABSTRACT

An electric wheel hub drive for a motor vehicle includes a wheel carrier, an electric engine, a stator carrier connected to the wheel carrier for conjoint rotation, and a rotor carrier connected to the rotor for conjoint rotation and mounted so as to be rotatable relative to the wheel carrier. The stator carrier has a disc section and a cylinder section arranged radially outside the disc section. The disc section has a first passage for a shaft of an actuator of a decoupler. A first coupling half and a second coupling half of the decoupler are arranged radially inside the cylinder section.

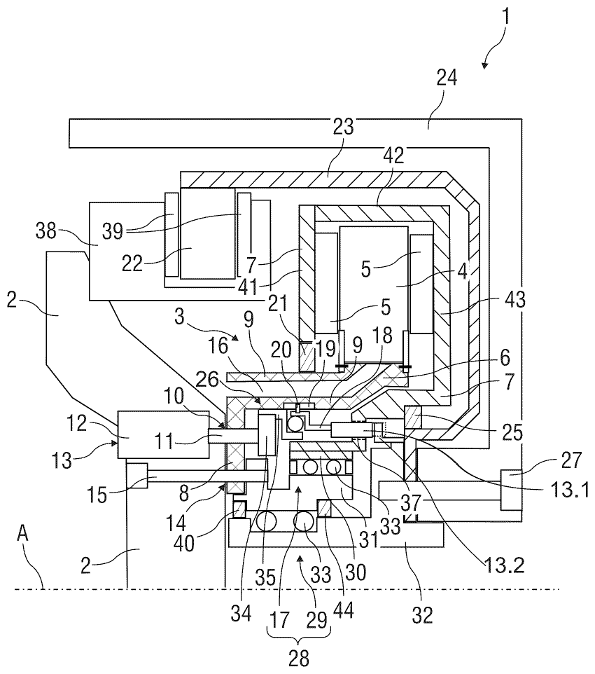

### BACKGROUND AND SUMMARY OF THE INVENTION

Exemplary embodiments of the invention relate to an electric wheel hub drive for a motor vehicle.

A decoupler (disconnect unit) can be used in an electric wheel hub drive for a motor vehicle. For example, a servomotor is used for actuating the decoupler.

Electric wheel hub drives are known for example from DE 10 2019 133 283 A1 and US 2019/0023128 A1 .

US 2020/0287495 A1 describes a control device for an electric motor having a first set of coil windings, which are arranged to form a first sub-motor, and a second set of coil windings, which are arranged to form a second sub-motor. The current flow in the first set of coil windings is controlled using a first pulse-width modulation (PWM) with a first switching sequence and the current flow in the second set of coil windings is controlled using a second PWM with a second switching sequence. The control device comprises means which are arranged to measure the current flow in each of the first set of coil windings, wherein after determining that the sum of the current flow in the first set of coil windings is substantially not zero, the first PWM values are derived from voltage values which are used to create the second PWM.

Exemplary embodiments of the invention are directed to a novel electric wheel hub drive for a motor vehicle.

In the context of the present application, the term “for conjoint rotation” is used as follows: Two elements are connected to each other for conjoint rotation when they are arranged coaxially to each other (in relation to their rotational axis or in relation to an axis of rotational symmetry) and when they are connected to each other in such a way that they always rotate at the same angular velocity. An element is connected to a housing for conjoint rotation when it cannot be rotated relative to the housing.

In the context of the present application, the term “radially overlapping” is used as follows: Two (in particular substantially rotationally symmetrical) elements are arranged radially overlapping in relation to a common axis when they are each at least partially arranged in a region of the same radial coordinates (in particular of the same angular coordinates).

In the context of the present application, the term “axially overlapping” is used as follows: Two elements are arranged axially overlapping with regard to a common axis when they are each at least partially arranged in a region of the same axial coordinates.

In the context of the present application, the term “radially inside” is used as follows: A first element is arranged radially inside a second element, in relation to a common axis, when the first element is arranged in a region of smaller radii than the second element.

According to the invention, an electric wheel hub drive for a motor vehicle is proposed, having a wheel carrier, having an electric engine which has a stator and a rotor arranged so as to be rotatable around a main rotational axis, having a stator carrier non-rotatably connected to the wheel carrier, having a rotor carrier connected to the rotor for conjoint rotation and mounted so as to be rotatable relative to the wheel carrier. The stator carrier has a disc section and a cylinder section arranged radially outside the disc section. According to the invention, the disc section has a first passage for a shaft of an actuator of a decoupler. The decoupler further has a first coupling half and a second coupling half, wherein according to the invention the first coupling half and the second coupling half are arranged radially inside the cylinder section.

The decoupler is designed to couple the rotor with a wheel rim for conjoint rotation or to decouple the rotor and wheel rim. The first coupling half and the second coupling half are in this case designed to produce a positive-locking or frictional connection. In a coupled state of the decoupler, the first coupling half and the second coupling half are connected to each other in a positive-locking or frictional manner. In a decoupled state, the first coupling half and the second coupling half are not connected to each other. The first coupling half and the second coupling half can be designed, for example, as coupling halves of a claw coupling or as coupling halves of a multiple-disc coupling.

In one embodiment, the disc section has second passages for screw connections, wherein the screw connections are designed to connect the disc section to the wheel carrier for conjoint rotation.

In one embodiment, the second passages are substantially arranged in a region of smaller radii than the first passage.

In one embodiment, the cylinder section has a channel which is designed for receiving a coolant.

In one embodiment, a rotor bearing is arranged radially inside the channel and axially overlapping the channel.

In one embodiment, the decoupler further has a ring arranged radially inside the cylinder section, wherein the ring is connected to the cylinder section for conjoint rotation and can be displaced axially relative to the cylinder section.

In one embodiment, the cylinder section has a groove on its radially inner side, which groove runs parallel to the main rotational axis, wherein the ring is connected to a pin which engages into the groove.

In one embodiment, the cylinder section has a sealing surface on its radially outer side for a seal with respect to the rotor carrier.

In one embodiment, the sealing surface is arranged axially between the stator and a brake disc.

In one embodiment, the stator carrier is designed as a single cast part.

In one embodiment, the decoupler further has a release bearing having splines into which a pinion arranged on the shaft engages, so that rotation of the shaft causes a rotation of the release bearing by means of the actuator, whereby the ring brings the first coupling half, which is axially displaceably mounted on the rotor carrier for conjoint rotation, into or out of engagement with the second coupling half, which is advantageously arranged on a brake disc carrier for conjoint rotation.

The stator carrier used according to the invention can provide passages for coolant and electrical cables. Furthermore, the stator carrier can provide a sealing surface for sealing with respect to the rotor. The stator carrier used according to the invention furthermore provides a connection for a mechanism for a decoupler (“disconnect mechanism”).

Exemplary embodiments of the invention are explained in more detail in the following using the drawing.

### BRIEF DESCRIPTION OF THE SOLE DRAWING FIGURE

The sole drawing FIGURE shows a schematic view of an electric wheel hub drive for a motor vehicle.

### DETAILED DESCRIPTIONS

The sole drawing FIGURE shows a schematic view of an electric wheel hub drive 1 for a motor vehicle, having a wheel carrier 2, having an electric engine 3 which has a stator 4 and a rotor 5 arranged so as to be rotatable around a main rotational axis A, having a stator carrier 6 non-rotatably connected to the wheel carrier 2, having a rotor carrier 7 connected to the rotor 5 for conjoint rotation and mounted so as to be rotatable relative to the wheel carrier 2, wherein the stator carrier 6 has a disc section 8 and a cylinder section 9, wherein the cylinder section 9 is arranged radially outside the disc section 8. The disc section 8 has a first passage 10 for a shaft 11 of an actuator 12 of a decoupler 13. A first coupling half 13.1 and a second coupling half 13.2 of the decoupler 13 is arranged radially inside the cylinder section 9. Advantageously, the first coupling half 13.1 and the second coupling half 13.2 have interfitting claw splines.

A rotational axis of the shaft 11 is arranged parallel to the main rotational axis.

In the embodiment, the disc section 8 has second passages 14 for screw connections 15, which are designed to connect the disc section 8 to the wheel carrier 2 for conjoint rotation.

Advantageously, the second passages 14 are substantially arranged in a region of smaller radii than the first passage 10.

Advantageously, the cylinder section 9 has at least one channel 16 designed for receiving a coolant. Particularly advantageously, the channel 16 has a first section arranged parallel to the main rotational axis A on a side facing towards the wheel carrier 2. Advantageously, the channel 16 has a second section in a region arranged axially overlapping the stator 4, which second section is arranged perpendicular to the main rotational axis A.

Advantageously, a rotor bearing 17 for rotationally bearing the rotor 5 is provided and is arranged radially inside and axially overlapping the channel 16.

Advantageously, the decoupler 13 has a displacement mechanism 26, designed to cause coupling and decoupling of the two coupling halves 13.1, 13.2. Advantageously, the displacement mechanism is designed to axially displace the first coupling half.

Advantageously, the displacement mechanism has a ring 18 arranged radially inside the cylinder section 9, wherein the ring 18 is connected to the cylinder section 9 for conjoint rotation and can be displaced axially relative to the cylinder section 9.

The ring 18 is coupled to the first coupling half 13.1, which is mounted axially displaceably in the respective passages 37 in the rotor carrier 7 and is designed for optional engagement with the second coupling half 13.2, which in turn is connected to a wheel rim 24 for conjoint rotation. Particularly advantageously, the second coupling half 13.2 is directly fixed on a brake disc carrier 23, wherein the brake disc carrier 23 is connected in turn to the wheel rim 24 for conjoint rotation.

Advantageously, the ring 18 is connected to the cylinder section 9 for conjoint rotation. The ring 18 is, however, arranged so as to be axially displaceable relative to the cylinder section 9. For connection to the ring 18 for conjoint rotation, the cylinder section 9 has a groove 19 on its radially inner side, which groove runs parallel to the main rotational axis A. The ring 18 is connected to an engagement element 20 which engages into the groove 19.

Furthermore, a pinion 34 is arranged on the shaft 11, which pinion is connected to the ring 18 via a release bearing 35 with splines. The pinion 34 is connected to the shaft 11 for conjoint rotation. The release bearing 35 has a ring shape arranged coaxially to the main rotational axis A and having the splines on its inner side which engage with pinion splines of the pinion 34. The release bearing has a ramp profile designed in such a way that the ring 18 can be displaced axially in the direction of the second coupling half by means of the ramp contour upon a corresponding rotation of the release bearing 35.

Advantageously, the ring 18 is arranged radially inside the cylinder section 9. Particularly advantageously, the entire displacement mechanism is arranged radially inside the cylinder section 9.

Advantageously, the cylinder section 9 has a sealing surface on its radial outer side for a seal 21, in particular a radial seal, with respect to the rotor carrier 7.

Advantageously, the sealing surface is arranged axially between the stator 4 and a brake disc 22.

The rotor bearing 17 is a part of a combined bearing 28, which further includes a wheel bearing 29. The combined bearing 28 has an outer bearing shell 30, a central bearing shell 31, and an inner bearing shell 32. A plurality of rolling elements 33 is arranged between the outer bearing shell 30 and the central bearing shell 31 which form the rotor bearing 17. A plurality of rolling elements 33 is arranged between the central bearing shell 31 and the inner bearing shell 32 which form the wheel bearing 29.

The brake disc 22 can be designed as an inside-out brake disc and can be arranged on the brake disc carrier 23 which is connected to the wheel rim 24 for conjoint rotation. The wheel rim 24 and the brake disc carrier 23 are connected to the inner bearing shell 32 of the wheel bearing 29 via several wheel screws 27 for conjoint rotation.

A further radial seal 25 can be arranged between the brake disc carrier 23 and the rotor carrier 7.

A brake caliper 38 with brake pads 39 is furthermore arranged on the wheel carrier 2. The brake caliper 38 can be designed as an internal brake caliper 38.

The wheel carrier 2, the brake caliper 38, the brake pads 39, the stator 4, the stator carrier 6, the actuator 12, the shaft 11, the pinion 34, and the central bearing shell 31 do not rotate with the wheel rim 24.

The brake disc 22, the brake disc carrier 23, the inner bearing shell 32, and the second coupling half always rotate together with the wheel rim 24.

The rotor carrier 7, the rotor 5, the decoupler pin 36, the ring 18, the engagement element 20, and the outer bearing shell 30 only rotate with the wheel rim 24 when the decoupler 13 is connected, this means when the first coupling half 13.1 is engaged with the second coupling half.

The electric engine 3 can be designed as an axial flux machine.

To seal a rotor space, in particular an intermediate space between the rotor 5 and the stator 4, a first seal 21 can arranged coaxially to the rotor carrier 7 in such a way that a first intermediate gap is filled by the first seal 21 between the rotor carrier 7 and the stator carrier 6.

A second seal 25 or further radial seal 25 can be arranged coaxially to the rotor carrier 7 in such a way that a second intermediate gap is filled between the rotor carrier 7 and the brake disc carrier 23 by the second seal 25.

With regard to the main rotational axis A, the second seal 25 can be arranged axially on a side of the first seal 21 facing away from the wheel carrier 2.

The second seal 25 can be arranged radially inside the stator 4, this means in particular radially inside the region of magnets arranged in the stator 4.

The first seal 21 can be arranged radially inside the rotor 5, this means in particular radially inside the region of magnets arranged in the rotor 5.

A first connection point for connecting the brake disc carrier 23 to the inner bearing shell 32 can be arranged radially inside the second seal 25.

The brake disc 22, which is connected to the brake disc carrier 23 for conjoint rotation, can be axially arranged on a side of the first seal 21 opposite the second seal 25 with regard to the main rotational axis A.

A third seal 40 can furthermore be arranged coaxially to the rotor carrier 7 in such a way that a third intermediate gap is filled by the third seal 40 between the central bearing shell 31, which can also be referred to as a first bearing ring, and the inner bearing shell 32, which can also be referred to as a second bearing ring.

Furthermore, there may be a second connection point for the sealed conjoint-rotation connection of the central bearing shell 31 to the stator carrier 6. Thus, the rotor space is closed: The stator carrier 6 has the cylinder section 9, which is sealed by means of the first seal 21 with respect to a first disc-shaped part 41 of the rotor carrier 7, which lies on one side of the stator 4 when viewed axially. The rotor carrier 7 furthermore has a cylindrical part 42 and a second disc-shaped part 43 connected to the cylindrical part 42 and sealed with respect to the brake disc carrier 23 by means of the second seal 25. The brake disc carrier 23 has a sealed connection point for the inner bearing shell 32. The inner bearing shell 32 is sealed with respect to the central bearing shell 31 by means of the third seal 40. The central bearing shell 31 has the sealed second connection point for connection to the stator carrier 6.

A fourth seal 44 can furthermore be provided between the inner bearing shell 32 and the central bearing shell 31 on the side of the wheel bearing 29 that is axially opposite the third seal 40.

The central bearing shell 31 can be designed as a single, integral bearing shell, which is both a radially outer part of the wheel bearing 29 and also a radially inner part of the rotor bearing 17. Alternatively, the central bearing shell 31 can also be designed as two bearing shells, connected to each other for conjoint rotation, of which one is a radially outer part of the wheel bearing 29 and the other is a radially inner part of the rotor bearing 17.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the FIGURE enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 electric wheel hub drive
2 wheel carrier
3 electric engine
4 stator
5 rotor
6 stator carrier
7 rotor carrier
8 disc section
9 cylinder section
10 passage
11 shaft
12 actuator
13 decoupler
13.1 first coupling half
13.2 second coupling half
14 passage
15 screw connection
16 channel
17 rotor bearing
18 ring
19 groove
20 engagement element
21 seal, first seal
22 brake disc
23 brake disc carrier
24 wheel rim
25 further radial seal, second seal
26 displacement mechanism
27 wheel screw
28 combined bearing
29 wheel bearing
30 outer bearing shell
31 central bearing shell
32 inner bearing shell
33 rolling elements
34 pinion
35 release bearing
37 passage
38 brake caliper
39 brake pad
40 third seal
41 first disc-shaped part
42 cylindrical part
43 second disc-shaped part
44 fourth seal
A main rotational axis

1-11. (canceled)

12. An electric wheel hub drive for a motor vehicle, the electric wheel hub drive comprising:
a wheel carrier;
a wheel rim;
an electric engine comprising a stator and a rotor arranged so as to be rotatable around a main rotational axis;
a stator carrier non-rotatably connected to the wheel carrier, wherein the stator carrier has a disc section and a cylinder section, wherein the cylinder section is arranged radially outside the disc section;
a rotor carrier connected to the rotor to conjointly rotate and mounted so as to be rotatable relative to the wheel carrier; and
a decoupler having an actuator, which includes a shaft,
wherein the disc section has a first passage for the shaft of the actuator of a decoupler,
wherein the decoupler is configured to connect the rotor to the wheel rim to conjointly rotate,
wherein a first coupling half and a second coupling half of the decoupler are arranged radially inside the cylinder section,
wherein the decoupler has a ring arranged radially inside the cylinder section, wherein the ring is connected to the cylinder section to conjointly rotate and is axially displaceable relative to the cylinder section,
wherein the cylinder section has a groove on a radially inner side of the cylinder section, wherein the groove runs parallel to the main rotational axis, and
wherein the ring is connected to an engagement element that engages into the groove.

13. The electric wheel hub drive of claim 12, wherein the disc section has second passages for screw connections, wherein the screw connections are configured to connect the disc section to the wheel carrier to conjointly rotate.

14. The electric wheel hub drive of claim 13, wherein the first coupling half is connected to the rotor carrier to conjointly rotate and the second coupling half is connected to the wheel rim to conjointly rotate.

15. The electric wheel hub drive of claim 12, wherein the cylinder section has a channel configured to receive a coolant.

16. The electric wheel hub drive of claim 15, wherein a rotor bearing is arranged radially inside in relation to the channel and axially overlapping the channel.

17. The electric wheel hub drive of claim 12, wherein the cylinder section has a sealing surface on a radially outer side of the cylinder section for a seal with respect to the rotor carrier.

18. The electric wheel hub drive of claim 17, wherein the seal is arranged axially between the stator and a brake disc.

19. The electric wheel hub drive of claim 12, wherein the stator carrier is a single cast part.

20. The electric wheel hub drive of claim 12, wherein the decoupler further comprising a release bearing having splines into which a pinion arranged on the shaft engages so that rotation of the shaft causes a rotation of the release bearing by the actuator, wherein the ring is configured to bring the first coupling half, which is axially displaceably mounted in the rotor carrier to conjointly rotate, into engagement with the second coupling half, which is connected to the wheel rim to conjointly rotate.
